(19) United States
(12) Patent Application Publication
(10) Pub. No.: US 2026/0320136 A1
(43) Pub. Date: Oct. 15, 2026

(54) NAMED ENTITY DICTIONARY AUTOMATIC UPDATE SYSTEM AND OPERATION METHOD THEREOF

(71) Applicants: HYUNDAI MOTOR COMPANY, SEOUL (KR); KIA CORPORATION, SEOUL (KR)

(72) Inventor: Hyung Sik Gim, Hwaseong-si (KR)

(73) Assignees: HYUNDAI MOTOR COMPANY, SEOUL (KR); KIA CORPORATION, SEOUL (KR)

(21) Appl. No.: 19/363,291

(22) Filed: Oct. 20, 2025

(30) Foreign Application Priority Data
Apr. 10, 2025 (KR) 10-2025-0046946

(51) Int. Cl. G06F 16/951; G06F 16/958; G06F 40/295

(52) U.S. Cl. CPC G06F 16/951; G06F 16/958; G06F 40/295

(57) ABSTRACT

A named entity dictionary automatic update system includes a webpage change detector that crawls a webpage at regular intervals to detect whether a named entity of the webpage is changed, an AI analyzer that generates a prompt to be used by a large-scale language model based on the named entity when the changed named entity is provided from the webpage change detector, and allows the large-scale language model to automatically generate a named entity and synonyms of the named entity using the generated prompt, an administrator approval requestor that transmits data of the named entity and the synonyms generated by the AI analyzer to an administrator terminal to request an approval, and an AI platform integrator that automatically reflects the named entity and the synonyms approved by the administrator terminal in a named entity dictionary of a conversational AI platform in response to the approval of the administrator terminal.

### CROSS-REFERENCE TO RELATED APPLICATION(S)

This application claims the benefit of priority to Korean Patent Application No. 10-2025-0046946, filed in the Korean Intellectual Property Office on Apr. 10, 2025, the entire contents of which are incorporated herein by reference.

### TECHNICAL FIELD

The present disclosure relates to a system for automatically updating a named entity dictionary and an operation method thereof, and more particularly, relates to a technology for updating a named entity dictionary of an artificial intelligence model in real time and automatically training and distributing the named entity dictionary whenever new content is uploaded onto a webpage.

### BACKGROUND

There are various technical attempts such as morphological analysis, named entity recognition, and syntactic analysis to analyze the linguistic content of documents written in various fields such as technology, humanities, and society. Here, the named entity recognition recognizes and extracts the named entity from input sentences and determines an appropriate named entity tag for the extracted named entity, which plays a useful role in various natural language processing fields. The named entity may be provided as uniquely used nouns or numeric expressions, such as people's names, place names, and organization names.

Relatedly, the named entity may be extracted from web documents containing information in a specific format such as tables or lists, and a named entity dictionary may be constructed using the named entity.

Also relatedly, a new named entity may be constructed, along with a new named entity variant dictionary based on a new entry word registered in an online encyclopedia.

Some conventional named entity dictionary construction methods are methods of manually entering and updating data. In addition, methods are used to manually analyze whether a webpage is updated or to extract a named entity using limited automation technology, and to reflect the extracted named entity in the knowledge base or named entity dictionary of an AI platform, so as to be distributed after training an AI model.

A conventional named entity dictionary construction method is described in FIG. 1.

FIG. 1 is a configuration diagram describing a conventional AI-based named entity dictionary automatic update system.

Referring to FIG. 1, when animal named entities such as giraffe and rabbit are added onto a webpage, an AI model may generate the added named entities and synonyms of the named entities. Then, the AI model may add the added named entities and the added synonyms into an animal named entity dictionary. After the AI model is trained, the animal named entity dictionary is distributed.

However, in the conventional system, the processes, such as from the process of adding the animal named entities in FIG. 1 to distribution, are carried out manually. Therefore, it takes a lot of time and effort to build the named entity dictionary, and it is also difficult to reflect (e.g., add) a new content to the AI model whenever new contents are created. For example, in an environment where the new content is uploaded in real time, it is useful to quickly update and recognize the named entity dictionary, but since the entire process of updating the named entity dictionary is carried out manually, it is challenging and time-consuming to update.

### SUMMARY

The present disclosure has been made to address the above-mentioned challenges occurring in the conventional art.

The present disclosure provides a system and method for automatically updating a named entity dictionary of an artificial intelligence model in real time and distributing the dictionary after training.

The present disclosure provides a system and method capable of automatically updating a named entity dictionary in real time whenever new content is uploaded onto a webpage.

The present disclosure is not limited to the aforementioned challenges, and other technical problems not mentioned herein may be understood from the following description.

According to the present disclosure, a named entity dictionary automatic update system includes a server and an administrator terminal. The server includes a webpage change detector that crawls a webpage at regular intervals to detect whether a named entity of the webpage is changed, an AI analyzer that generates a prompt to be used by a large-scale language model based on the named entity based on the changed named entity provided from the webpage change detector, and allows the large-scale language model to automatically generate a named entity and synonyms of the named entity using the generated prompt. The server may also include an administrator approval requestor that transmits data of the named entity and the synonyms generated by the AI analyzer to the administrator terminal to request an approval. The server further may include an AI platform integrator that automatically reflects the named entity and the synonyms approved by the administrator terminal in a named entity dictionary of a conversational AI platform in response to the approval of the administrator terminal, and allows the AI platform to apply to an artificial intelligence model after training based on updated information, and the named entity dictionary is updated in real time whenever a content of the webpage is uploaded.

According to an example embodiment, the webpage change detector may include a DOM tree generator that analyzes an HTML document of the webpage to generate a DOM tree structure, a tree edit distance calculator that calculates a tree edit distance to measure a structural difference between a DOM tree generated by the DOM tree generator and a previous DOM tree, and a processing device that identifies and determines whether the webpage is updated based on the calculated tree edit distance.

According to an example embodiment, the webpage change detector may further include a DOM tree comparator that compares the DOM tree generated by the DOM tree generator with a previously stored DOM tree.

According to an example embodiment, the tree edit distance may include minimum edit calculation items (e.g., required) to transform one tree into another tree, and the minimum edit calculation items may include insertion, deletion, and replacement.

According to an example embodiment, the processing device (e.g., processor) may determine that there is a structural difference between the two trees based on a result of the tree edit distance being greater than “0” (zero), and may process the tree edit distance with priority over other tree edit distances based on the tree edit distance exceeded a preset threshold value.

According to an example embodiment, the AI analyzer may include a vector embedding generator that embeds the named entity N_{V} and a named entity synonym Nₛ in a vector space to generate embedding vectors E_{V} and Eₛ, and a similarity calculator that measures a similarity between the embedding vectors E_{V} and Eₛ of the generated named entity and the named entity synonym.

According to an example embodiment, the similarity calculator may calculate the similarity using a cosine similarity, and may calculate the similarity between the two embedding vectors E_{V} and Eₛ using Equation

$${cosine}_{similarity ( {E}_{v} , {E}_{s} )} = \frac{{E}_{v} \cdot {E}_{s}}{‖ {E}_{v} ‖ ‖ {E}_{s ‖}} ,$$

where E_{V}·Eₛ is a dot product of the embedding vectors E_{V} and Eₛ, and ∥Eᵥ∥∥Eₛ∥ represents a norm of the embedding vectors E_{V} and Eₛ.

According to an example embodiment, the AI analyzer may add the named entity into a blacklist and regenerate the named entity based on the generated named entity already existing, and may add the generated synonym into the blacklist to prevent duplicate generation and may regenerate the named entity based on the similarity that does not meet a criteria as a result of the similarity calculation.

According to an example embodiment, the AI analyzer may further determine whether the number of synonyms for the generated named entity satisfies a preset criteria, and may add the generated synonyms into a blacklist to prevent duplicate generation and then may regenerate the named entity based on the number of synonyms that does not meet the preset criteria.

According to an example embodiment, the administrator terminal may receive an approval request for the named entity and the synonym data from the administrator approval requestor, and may select one of approval, cancellation, and regeneration requests from an administrator menu to respond to the server.

According to the present disclosure, a method of operating a named entity dictionary automatic update system is provided. The system may include a server and an administrator terminal. The server may include a webpage change detection operation which crawls a webpage at regular intervals and detects whether a named entity of the webpage is changed, and an AI analysis operation which generates a prompt to be used by a large-scale language model based on the named entity based on the changed named entity provided from the webpage change detection operation, and allows the large-scale language model to automatically generate a named entity and synonyms of the named entity, using the generated prompt. The server may also include an administrator approval request operation which transmits data of the named entity and the synonyms generated by the AI analysis operation to the administrator terminal to request approval, and an AI platform integration operation which automatically reflects the named entity and the synonyms approved by the administrator terminal in a named entity dictionary of a conversational AI platform in response to the approval of the administrator terminal, and allows the AI platform to apply to an artificial intelligence model after training based on updated information, and the named entity dictionary is updated in real time whenever a content of the webpage is uploaded.

According to an example embodiment, the webpage change detection operation may include a DOM tree generation operation which analyzes an HTML document of the webpage to generate a DOM tree structure, a tree edit distance calculation operation which calculates a tree edit distance to measure a structural difference between the generated DOM tree from the DOM tree generation operation and a previous DOM tree, and a processing operation which identifies and determines whether the webpage is updated based on the calculated tree edit distance.

According to an example embodiment, the webpage change detection operation may further include a DOM tree comparison operation which compares the generated DOM tree from the DOM tree generation operation with a previously stored DOM tree.

According to an example embodiment, the tree edit distance may include minimum edit calculation items required to transform one tree into another tree, and the calculation items may include insertion, deletion, and replacement.

According to an example embodiment, the processing operation may determine that there is a structural difference between the two trees based on a result of the tree edit distance being greater than “0” (zero), and may process the tree edit distance with priority over other tree edit distances based on the tree edit distance exceeded a preset threshold value.

According to an example embodiment, the AI analysis operation may include a vector embedding generation operation which embeds the named entity N_{V} and a named entity synonym Nₛ in a vector space to generate embedding vectors E_{V} and Eₛ, and a similarity calculation operation which measures a similarity between the embedding vectors E_{V} and Eₛ of the generated named entity and the named entity synonym.

According to an example embodiment, the similarity calculation operation may calculate the similarity using a cosine similarity, and may calculate the similarity between the two embedding vectors E_{V} and Eₛ using Equation

$${cosine}_{similarity ( {E}_{v} , {E}_{s} )} = \frac{{E}_{v} \cdot {E}_{s}}{‖ {E}_{v} ‖ ‖ {E}_{s ‖}} ,$$

where E_{V}·Eₛ may be a dot product of the embedding vectors E_{V} and Eₛ, and ∥Eᵥ∥∥Eₛ∥ may represent a norm of the embedding vectors E_{V} and Eₛ.

According to an example embodiment, the AI analysis operation may add the named entity into a blacklist and regenerate the named entity based on the generated named entity existing, and may add the generated synonym into the blacklist to prevent duplicate generation and may regenerate the named entity based on the similarity that does not meet a criteria as a result of the similarity calculation.

According to an example embodiment, the AI analysis operation may further determine whether the number of synonyms for the generated named entity satisfies a preset criteria, and may add the generated synonyms into a blacklist to prevent duplicate generation and then may regenerate the named entity based on the number of synonyms that does not meet the preset criteria.

According to an example embodiment, the administrator terminal may select one of approval, cancellation, regeneration requests of an administrator menu to respond to the server based on an approval request for the named entity and the synonym data received from the administrator approval request operation.

### BRIEF DESCRIPTION OF THE DRAWINGS

The above and other objects, features and advantages of the present disclosure will be more apparent from the following detailed description taken in conjunction with the accompanying drawings:

FIG. 1 is a configuration diagram of a conventional AI-based named entity dictionary automatic update system.

FIG. 2 is an overall configuration diagram illustrating an AI-based named entity dictionary automatic update system, according to an example embodiment of the present disclosure.

FIG. 3 is a configuration diagram illustrating an overall system for a named entity dictionary automatic updater, according to an example embodiment of the present disclosure.

FIG. 4 is a server configuration diagram for implementing a named entity dictionary automatic update system of FIG. 3.

FIG. 5 is a detailed internal configuration diagram of a webpage change detector of FIG. 4.

FIG. 6 is a detailed internal configuration diagram of an AI analyzer of FIG. 4.

FIG. 7 is a diagram illustrating an overall operation mechanism for a named entity dictionary automatic updater, according to an example embodiment of the present disclosure.

FIG. 8 is an overall flowchart illustrating a named entity dictionary automatic update method, according to another example embodiment of the present disclosure.

FIG. 9 is a flowchart illustrating a webpage change detection operation of FIG. 8 in detail.

FIG. 10 is a diagram illustrating an example of a webpage being changed.

FIG. 11 is a flowchart illustrating an AI analysis operation of FIG. 8 in detail.

FIG. 12 is a diagram illustrating an example of an operation of an AI analyzer.

FIG. 13 is a flowchart illustrating an administrator approval request operation of FIG. 8 in detail.

FIG. 14 is a flowchart illustrating an AI platform update operation of FIG. 8 in detail.

FIG. 15 is an example screen provided as a search result by reflecting a named entity and synonyms added to a named entity dictionary by a server during an AI platform update operation of FIG. 14.

FIG. 16 is a configuration diagram of a computing system, according to an example embodiment of the present disclosure.

### DETAILED DESCRIPTION

Hereinafter, some example embodiments of the present disclosure are described in detail with reference to the accompanying drawings. In adding the reference numerals to the components of each drawing, it should be noted that the same or equivalent component is designated by the same numeral even when they are displayed on other drawings. In addition, a detailed description of some features or functions may be omitted.

In describing the components of the example embodiment according to the present disclosure, the terms first, second, A, B, (a), (b), and the like may be used herein. These terms are intended to distinguish the components from other components, and the terms do not limit the nature, order or sequence of the components. Unless otherwise defined, (e.g., all) terms including technical and scientific terms used herein have the same meaning as commonly understood by one of ordinary skill in the art to which this disclosure belongs. It will be further understood that terms, such as those provided in commonly used dictionaries, should be interpreted as having a meaning that is consistent with their meaning in the context of the relevant art and will not be interpreted in an idealized or overly formal sense unless expressly so provided herein.

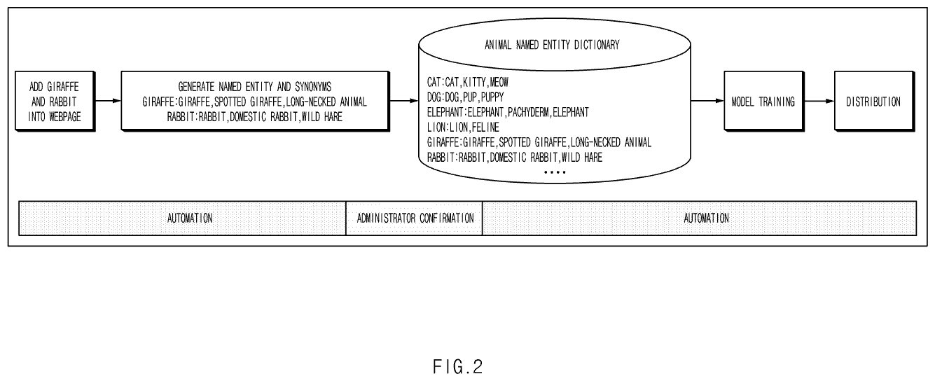

Hereinafter, example embodiments of the present disclosure will be described in detail with reference to FIGS. 2 to 16.

FIG. 2 is an overall configuration diagram illustrating an AI-based named entity dictionary automatic update system, according to an example embodiment of the present disclosure.

Referring to FIG. 2, the present disclosure describes that when an animal named entity, such as a giraffe or a rabbit, is added onto a webpage, the added named entity and synonyms of the named entity are created and uploaded into the animal named entity dictionary, and the entire process of distributing a trained AI model is automatically performed.

In FIG. 2, an administrator confirmation process may be used (e.g., required only) when the added named entity and the synonyms are uploaded into the named entity dictionary.

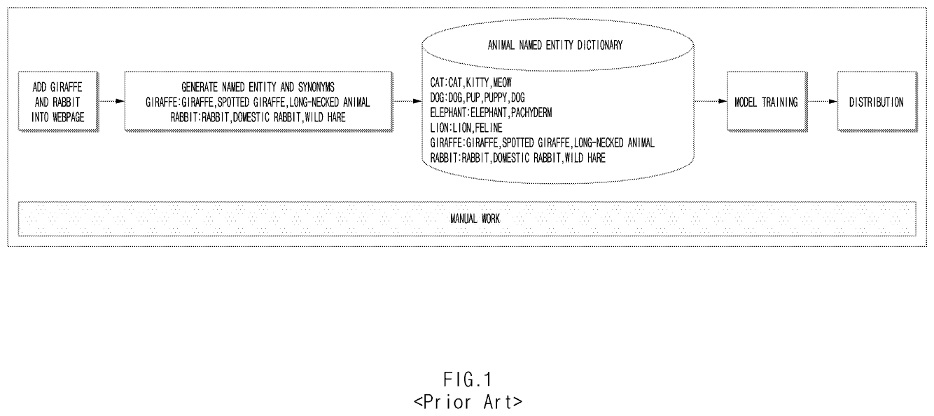

Since the automatic update of the named entity dictionary of FIG. 2 is performed automatically, it may be seen that the entity dictionary may be built more quickly, as compared to the conventional art of FIG. 1, and the named entity dictionary may be quickly updated in an environment where new content is uploaded in real time.

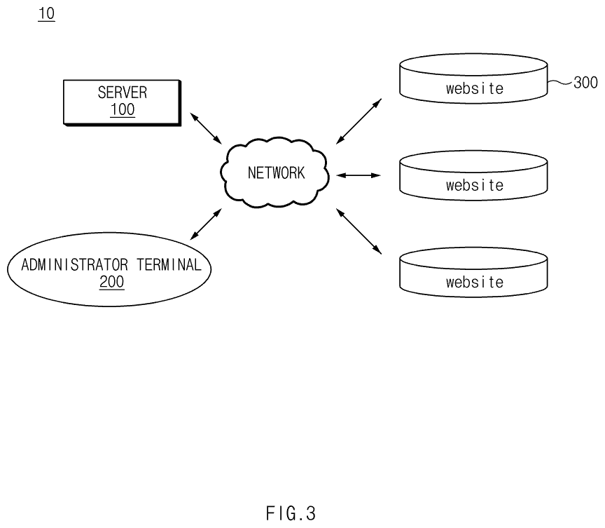

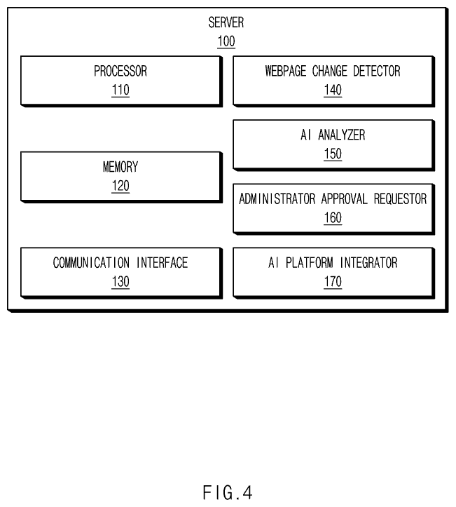

FIG. 3 is a configuration diagram illustrating an overall system for a named entity dictionary automatic updater, according to an example embodiment of the present disclosure, and FIG. 4 is a server configuration diagram for implementing a named entity dictionary automatic update system of FIG. 3.

Referring to FIGS. 3 and 4, a system 10 may be configured to include a server 100 and an administrator terminal 200. Also, FIG. 3 illustrates a website (e.g., a webpage) 300. This is to update the named entity dictionary by determining whether the named entity of the webpage 300 is changed.

The server 100 may include at least a processor 110, a memory 120, and a communication interface 130.

The processor 110 may be implemented as a digital signal processor (DSP) for processing digital signals, a microprocessor, or a TCON (Time controller). However, the present disclosure is not limited thereto, and may include one or more of a central processing unit (CPU), a micro controller unit (MCU), a micro processing unit (MPU), a controller, an application processor (AP), a graphics-processing unit (GPU), a communication processor (CP), and an address resolution protocol processor (ARP processor). In addition, the processor may be implemented as an SoC (System on Chip), an LSI (Large Scale Integration) with a built-in processing algorithm, or may be implemented in the form of an FPGA (Field Programmable Gate Array).

The memory 120 may be implemented as a non-volatile memory, a volatile memory, a flash memory, a hard disk drive (HDD), or a solid state drive (SSD). The memory 120 is accessed by the processor 110, and data reading/recording/modifying/deleting/updating may be performed by the processor 110. In the example embodiment, the term of the memory 120 may include a ROM within the processor 110, a RAM, or a memory card (e.g., a micro SD card or a memory stick).

The communication interface 130 may connect the server 100, the administrator terminal 200, and the website 300 to each other. In an example embodiment, the communication interface 130 may include various wireless networks such as a short-range wireless communication network, a wireless communication network, or the like. In this case, the short-range wireless communication network may be a network for performing communication according to a short-range wireless communication method such as a Bluetooth (BT), a BLE (Bluetooth Low Energy), a ZigBee, or the like. In addition, the wireless communication network may be a wireless personal area network (WPAN), a Wi-Fi (IEEE 802.11), a wireless local area network (WLAN), a low power WLAN, a ZigBee, or a CSMA-based wireless network. In addition, the communication method may be a communication that collaborates with the Internet, LANs (Local Area Networks), WANs (Wide Area Networks), VPNs (Virtual Private Networks), and the cloud, etc., or other possible forms of communication.

In an example embodiment, the server 100 may be configured to include a webpage change detector 140, an AI analyzer 150, an administrator approval requestor 160, and an AI platform integrator 170. The processor 110 may control operations of the components. Herein, the server 100 may perform a specific operation providing that the processor 110 may perform the specific operation. In addition, the server 100 performing a specific operation may be understood as the processor 110 allowing the hardware components included in the server 100, such as the webpage change detector 140, the AI analyzer 150, the administrator approval requestor 160, and/or the AI platform integrator 170, to perform the specific operation. Also, the server 100 performing a specific operation may be understood as the memory 120 storing instructions that cause the processor 110 or at least one of the components to perform the specific operation.

In an example embodiment, the webpage change detector 140, the AI analyzer 150, the administrator approval requestor 160, and the AI platform integrator 170 included in the server 100 may have at least one component added, changed, or deleted depending on the performance and/or type of the server 100. In addition, the webpage change detector 140, the AI analyzer 150, the administrator approval requestor 160, and/or the AI platform integrator 170 may be built within the server 100 or may be built as separate configurations outside of the server 100. That is, the location or position of the configurations may be changed depending on the performance or structure of the server 100.

In an example embodiment, the server 100 may be configured to be composed of (e.g., comprise or include) multiple servers and perform distributed processing.

In FIG. 4, the server 100 manages an organic process flow and may enable smooth communication by coordinating the interaction and data flow between the webpage change detector 140, the AI analyzer 150, the administrator approval requestor 160, and the AI platform integrator 170. In addition, the server 100 monitors the network connection through the communication interface 130, corrects the stable operation of the system through handling of exceptions, and manages logs and settings to analyze and resolve the cause when a problem occurs. In addition, the server 100 (e.g., continuously) monitors the status of the webpage change detector 140, the AI analyzer 150, the administrator approval requestor 160, and the AI platform integrator 170 and performs (e.g., necessary) management tasks to maintain the (e.g., optimal) performance and stability of the system.

In FIG. 4, the webpage change detector 140 may detect changes when new named entity information is input or existing named entity information is modified based on a DOM (Document Object Model) tree structure in the webpage 300. The webpage change detector 140 crawls the webpage 300 at regular intervals (e.g., by date, hour, minute) to generate a DOM tree, and then identifies the changed portion by comparing the generated DOM tree with the previous DOM tree to detect whether the webpage is changed. In an example embodiment, the “apscheduler” library is used for scheduling to identify the changed portion, and the “BeautifulSoup” library may be used for web crawling and DOM parsing.

In FIG. 4, the AI analyzer 150 receives changed named entity information from the webpage change detector 140 and (e.g., automatically) generates an appropriate named entity and synonyms using a large-scale language model (LLM). To this end, an output format of the generated information, a list of the named entity and the synonyms currently in use, and a list (a blacklist) of named entities and synonyms that should not be generated may be specified in a prompt. In addition, the generated named entity and synonyms may be evaluated for similarity with a target named entity through cosine similarity, and may be added to the final named entity list (e.g., only) when the similarity exceeds a certain criteria.

In FIG. 4, the administrator approval requestor 160 may request the administrator terminal 200 for the named entity and synonym data generated by the AI analyzer 150 to receive final approval from the administrator. The administrator includes one or more persons who have specific qualification, wherein the specific qualification includes reviewing the named entity and synonym data generated by the AI analyzer 150 provided through the administrator terminal. After reviewing the provided message, the administrator may decide whether to reflect the named entity and the synonyms in the AI platform. The message transmitted to the administrator may include the changed data in the webpage 300 and the named entity and synonym list generated depending on the changed data, and the administrator approval requestor 160 may provide an administrator menu so that the administrator may select approval, cancellation, and regeneration requests. In an example embodiment, the series of processes for the administrator approval requestor 160 to receive approval from the administrator may include various methods, such as SNS, collaboration tools, email, and text messages.

In FIG. 4, the AI platform integrator 170 may automatically reflect the named entity and the synonyms approved by the administrator into the named entity dictionary of a conversational AI platform. The AI platform may train based on the updated information and then apply the updated information to the final artificial intelligence model. The AI platform integrator 170 may be implemented to reflect the named entity and the synonyms using a client library of the AI platform.

Next, each configuration (e.g., detector, analyzer, requestor, and/or integrator) illustrated in FIG. 4 will be described in more detail.

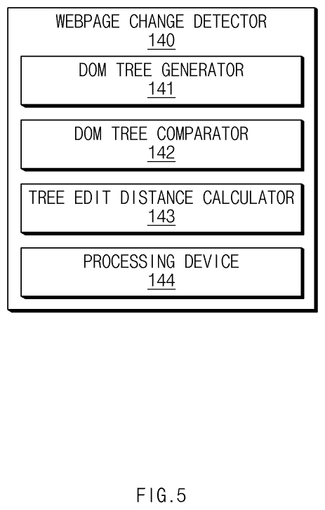

FIG. 5 is a detailed internal configuration diagram of a webpage change detector of FIG. 4.

A method for detecting changes in the webpage 300 may be detected by comparing Document Object Model (DOM) tree structures between two HTML documents. The DOM may express an HTML document in a tree structure.

In an example embodiment, the webpage change detector 140 uses a webpage change method based on the DOM tree. The DOM tree-based comparison method is useful to identify (e.g., faster and more precise) structural differences than the conventional string-based comparison method.

Referring to FIG. 5, the webpage change detector 140 may include a DOM tree generator 141, a DOM tree comparator 142, a tree edit distance calculator 143, and a processing device 144.

The DOM tree generator 141 may analyze an HTML document of the webpage 300 to generate a DOM tree structure. HTML elements are expressed as nodes of a tree, and a tree structure may be generated through a parent-child relationship. Using the DOM tree structure, structural information of the webpage 300 may be expressed, and the DOM tree comparator 142 may compare two HTML documents.

The tree edit distance calculator 143 may measure the structural difference between the DOM tree generated by the DOM tree generator 141 and the previous DOM tree using the tree edit distance (TED) algorithm. In this case, the tree edit distance may be provided (e.g., defined) as the minimum number of edit calculations (e.g., insertion, deletion, replacement, etc.) used (e.g., required) to convert one tree into another tree.

The tree edit distance algorithm may be provided by a recursive formula, such as the following Equation 1.

$$TED ( {T}_{1} , {T}_{2} ) = min ( \begin{matrix}TED ( {T}_{1} - 1 , {T}_{2} ) + Cost ( Delete ) \\ TED ( {T}_{1} , {T}_{2} - 1 ) + Cost ( Insert ) \\ TED ( {T}_{1} - 1 , {T}_{2} - 1 ) + Cost ( Rename )\end{matrix} ) \qquad 〈 Equation 1 〉$$

In Equation 1, T₁, T₂ are two trees being compared, respectively, TED(T₁−1, T₂) is the edit distance when deleting a node from tree T₁ and comparing it with tree T₂, TED(T₁, T₂−1) is the edit distance when inserting a node from tree T₂ and comparing it with tree T₁, TED(T₁−1, T₂−1)+Cost(Rename) is the edit distance when replacing a node of tree T₁ with a node of tree T₂, Cost(Delete)/Cost(Insert)/Cost(Rename) represents the cost for the deletion, insertion, and replacement calculations of nodes, respectively.

The processing device 144 may determine that there is a structural difference between the two trees when the result of the tree edit distance TED(T₁, T₂) is greater than 0 (zero), for example. In addition, when there is a structural difference, the processing device 144 may identify and process updates or changes of the webpage 300. For example, when the value of the tree edit distance TED(T₁, T₂) exceeds a specific threshold value, the processing device 144 may identify that the update or change is relatively more important than other tree edit distance values, and may process it with a higher priority.

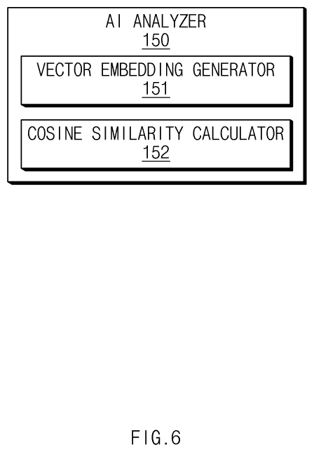

FIG. 6 is a detailed internal configuration diagram of an AI analyzer of FIG. 4.

Referring to FIG. 6, the AI analyzer 150 may include a vector embedding generator 151 and a cosine similarity calculator 152.

The vector embedding generator 151 may embed a named entity value N_{V} and the named entity synonym Nₛ in a vector space to generate the embedding vectors E_{V} and Eₛ. The embedding vectors E_{V} and Eₛ may be generated by converting each word into a high-dimensional vector using a pre-trained embedding model (e.g., Word2Vec or FastText). That is, Eᵥ=Embedding(Nᵥ), Eₛ=Embedding(Nₛ).

Here, N_{V} is the named entity value generated using a generative AI, Nₛ is the synonym of the named entity value generated using the generative AI, and the embedding vectors E_{V} and Eₛ, are values that express the named entity value and the synonym as vectors.

The cosine similarity calculator 152 may measure the similarity between two embedding vectors. The cosine similarity between the two embedding vectors E_{V} and Eₛ may be provided as in the following Equation 2.

$${cosine}_{similarity ( {E}_{v} , {E}_{s} )} = \frac{{E}_{v} \cdot {E}_{s}}{‖ {E}_{v} ‖ ‖ {E}_{s ‖}} \qquad 〈 Equation 2 〉$$

In Equation 2, E_{V}·Eₛ is the dot product of the embedding vectors E_{V} and Eₛ, and ∥Eᵥ∥∥Eₛ∥ is the norm of the embedding vectors E_{V} and Eₛ. In addition, the vector dot product may be expressed as

$${E}_{v} \cdot {E}_{s} = {\sum }_{i = 1}^{n} {E}_{v , i} {E}_{s , i} ,$$

and the vector norm may be expressed as

$$‖ {E}_{v} ‖ = \sqrt{{\sum }_{i = 1}^{n} {E}_{v , i}^{2}} , ‖ {E}_{s} ‖ = \sqrt{{\sum }_{i = 1}^{n} {E}_{s , i}^{2}} ,$$

Therefore, the cosine similarity calculator 152 calculates the cosine similarity using the Equation 2 using the vector dot product and the vector norm.

In an example embodiment, when the cosine similarity between the two embedding vectors is greater than a preset threshold value φ (if cosine_{similarity(E}_{ᵥ}_{,E}_{ₛ}₎≥φ), the named entity value N_{V} and the named entity synonym Nₛ may be determined to be similar.

Here, with regard to the threshold value setting, for example, when the threshold value is 0.7 to 0.8, the similarity may be set to be high. That is, it may be the case that the named entity and the synonym are quite similar.

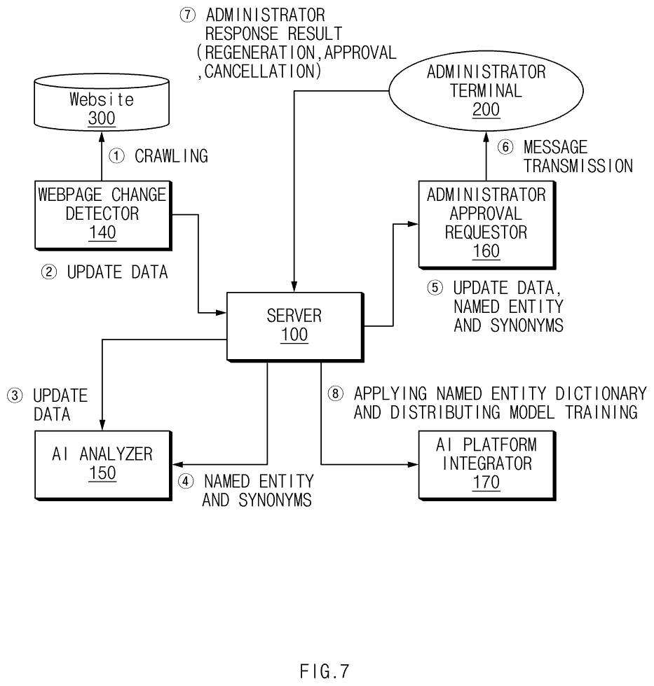

FIG. 7 is a diagram illustrating an overall operation mechanism for a named entity dictionary automatic updater, according to an example embodiment of the present disclosure.

Referring to FIG. 7, the webpage change detector 140 crawls the webpage 300 at a regular interval (e.g., by date, hour, minute) to convert the HTML code of the webpage 300 into a DOM tree, and detects whether the webpage is changed using the Tree Edit Distance (TED) algorithm. When the detection result indicates that the webpage is changed, the updated data of the webpage may be provided to the server 100.

The server 100 transfers the updated data of the webpage to the AI analyzer 150. The AI analyzer 150 may (e.g., automatically) generate the named entities and the synonyms based on a prompt (LLM_PROMPT) using a large-scale language model (LLM) and a generative AI. The generated named entity and the synonyms may be provided to the server 100.

The server 100 may transmit the named entity and the synonyms generated by the generative AI to the administrator terminal 200 for administrator approval. The administrator may review the named entity and the synonyms and may decide whether to reflect them in the AI platform. Based on this decision, the administrator may select one of the approval, regeneration, or cancellation (rejection) provided in the administrator menu and may provide the administrator response result to the server 100.

When the named entity and the synonyms are approved by the administrator, the server 100 may update the named entity dictionary of the conversational AI platform by transmitting them to the AI platform integrator 170, so as to be reflected. The AI platform performs training based on the updated information and then applies an improved version to a final artificial intelligence model.

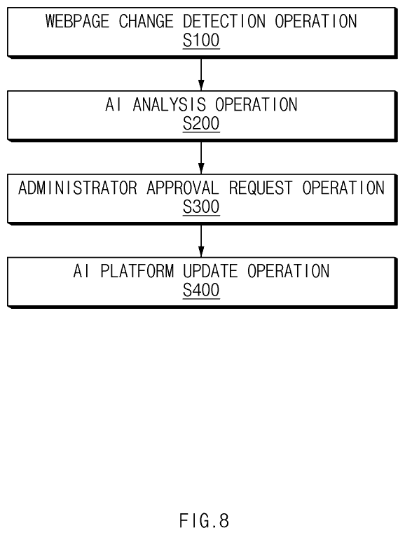

FIG. 8 is an overall flowchart illustrating a named entity dictionary automatic update method, according to another embodiment of the present disclosure.

Referring to FIG. 8, a method of the present disclosure may be performed by including a webpage change detection operation (S100) in which the server 100 detects a webpage change when new information is input or existing information is modified based on a DOM (Document Object Model) tree structure in the webpage 300. The method may also include an AI analysis operation (S200) in which the server 100 receives the changed data of the webpage 300 and automatically generates an appropriate named entity and synonyms by utilizing a large-scale language model (LLM), an administrator approval request operation (S300) in which the server 100 requests the administrator to provide the generated named entity and the synonyms for final approval by the administrator, and an AI platform update operation (S400) in which the server 100 automatically reflects the named entity and the synonyms that are approved for the request into the named entity dictionary of the AI platform.

The named entity dictionary may be updated in real time whenever new content is uploaded onto the webpage 300, according to the named entity dictionary automatic update method of FIG. 8.

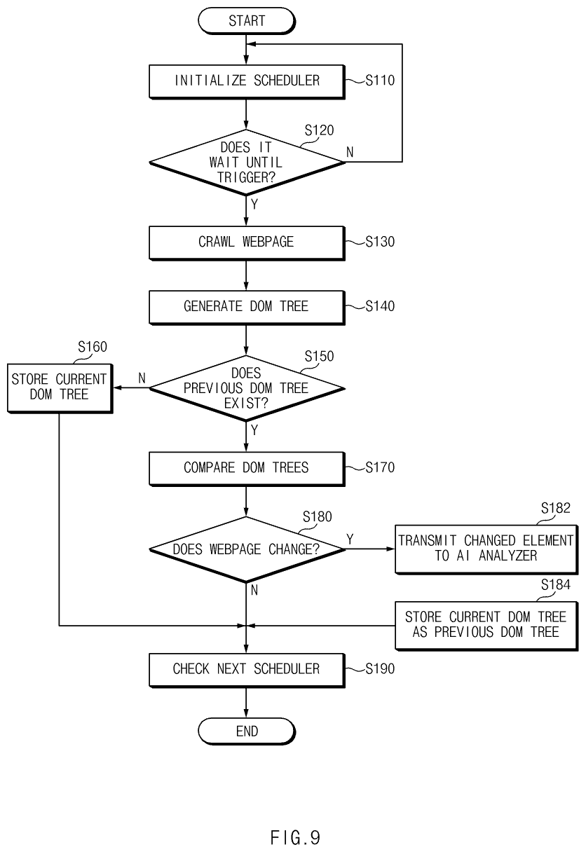

Each operation described in FIG. 8 are provided in more detail with reference to FIGS. 9 to 12.

FIG. 9 is a flowchart illustrating a webpage change detection operation of FIG. 8.

The webpage change detection operation (S100) may be initiated by the webpage change detector 140 being operated.

In the example embodiment, the webpage change detector 140 initializes a scheduler to perform a task at regular intervals using, for example, the “python apscheduler” library (S110). In addition, after the scheduler is initialized, the webpage change detector 140 maintains a standby state until it is triggered at a preset time (S120). Then, the webpage change detector 140 crawls the webpage 300 at regular intervals using, for example, the “BeautifulSoup” library to obtain the HTML document of the webpage (S130).

The HTML document of the webpage 300 is transferred to the DOM tree generator 141. The DOM tree generator 141 may analyze the HTML document of the webpage 300 to generate a DOM tree structure (S140). As mentioned herein, by using the DOM tree structure, the DOM tree comparator 142 may compare two HTML documents.

When the DOM tree generator 141 generates the DOM tree, whether a previously saved DOM tree exists is determined (S150), and when there is no saved DOM tree, the DOM tree generated by the DOM tree generator 141 is saved and then waited for (S160). In contrast, when there is a previously saved DOM tree, the DOM tree comparator 142 compares the DOM tree generated by the DOM tree generator 141 with the previous DOM tree (S170).

The comparison result of the DOM tree comparator 142 is transferred to the tree edit distance calculator 143. The tree edit distance calculator 143 measures the structural difference between two DOM trees (e.g., the generated DOM tree and the previous DOM tree) using the tree edit distance (TED) algorithm of the Equation 1. Through this, elements may be identified that are newly added, deleted, or changed.

The processing device 144 may use the calculation result of the tree edit distance calculator 143 to determine whether a change occurs in the webpage (S180). For example, when the result of the tree edit distance TED(T₁, T₂) is greater than 0 (zero), the processing device 144 may determine that there is a structural difference between the two trees. In this case, when a specific threshold value is given, and when the tree edit distance value exceeds the specific threshold value, the element may be (e.g., designed to be) processed with priority.

When there is a structural difference between the trees in this way, and when the processing device 144 detects that a change occurs in the webpage 300, the processing device 144 transmits the changed element to the AI analyzer (S182). Then, the generated DOM tree is considered as the previous DOM tree and stored (S184).

When this process is completed, the scheduler waits until it is triggered (e.g., again) (S190), and when all processing is completed, the operation of the webpage change detector 140 may be terminated.

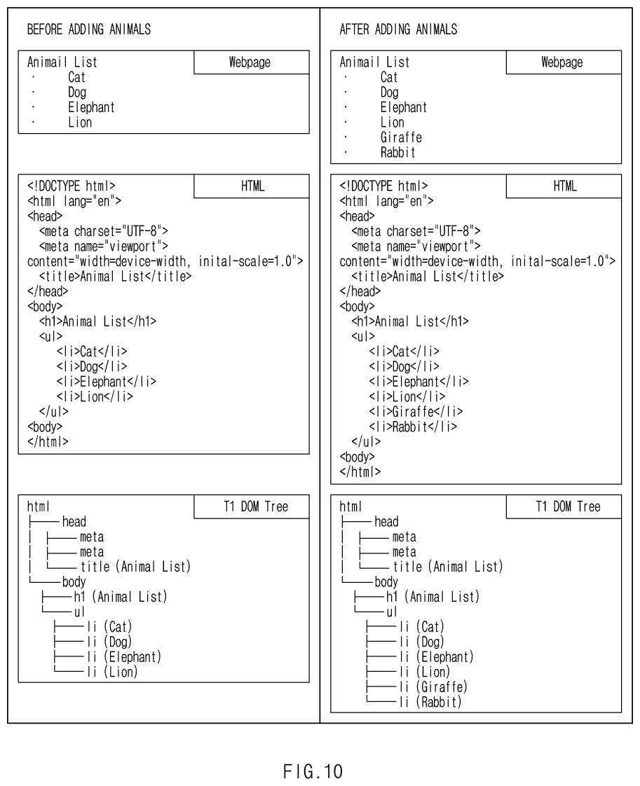

FIG. 10 is a diagram illustrating an example of a webpage being changed.

In FIG. 10, the left side is before adding an animal, and the right side is when a new animal is added.

Looking at this, when Giraffe and Rabbit are added onto the webpage 300, it may be seen that <li>Giraffe<li>, <li>Rabbit</li> are displayed in the HTML document in correspondence with the added animals. Looking at the result of the DOM tree generator 141 generating the DOM tree, it may be seen that ‘li (Giraffe)’, ‘li (Rabbit)’ are also displayed.

In FIG. 10, the previous DOM tree (T1 DOM Tree) and the generated DOM tree (T2 DOM Tree) are compared, and thus, the inserted elements may be identified.

Meanwhile, in the webpage change detection operation (S100), when two animals are added as described above, according to Equation 1, insertion costs may be incurred in the insertion calculation that should insert the added li (Giraffe) and li (Rabbit) nodes. When, on the contrary, in the deletion calculation where the animal is deleted, there is no deleted node, so the deletion cost does not occur. As provided herein, in the case of the replacement calculation where each li node has the same text value, the replacement calculation cost does not occur.

In addition, since the final tree edit distance calculation requires two insertion calculations, it may be expressed as TED(T₁, T₂)=2.

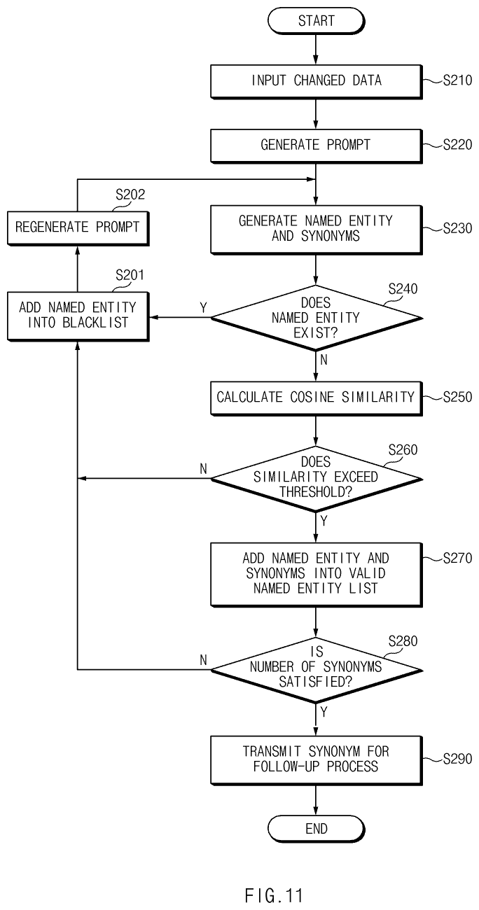

FIG. 11 is a flowchart illustrating an AI analysis operation of FIG. 8 in detail.

The AI analysis operation (S200) may be initiated by the AI analyzer 150 being operated.

The AI analyzer 150 receives the changed data of the webpage from the webpage change detector 140 (S210). In addition, based on the changed data of the webpage 300, the AI analyzer 150 generates a prompt to be used by the large-scale language model (LLM) (S220). The prompt may provide instructions for generating (e.g., appropriate) named entities and the synonyms. For example, an output format of the generated information, a list of the named entity and the synonyms currently in use, and a list (a blacklist) of named entities and synonyms that should not be generated may be specified in a prompt.

The AI analyzer 150 allows the large-scale language model to automatically generate the named entities and their corresponding synonyms using the generated prompt (S230). The AI analyzer 150 then determines whether the generated named entity exists (S240). When the named entity already exists, the named entity is added into the blacklist to avoid duplicate generation (S201), and the prompt is regenerated to return to the operation of regenerating the named entity (S202).

The generated named entity and the synonyms are evaluated for similarity through cosine similarity. The similarity between the named entity and the synonym is evaluated, and (e.g., only) when the similarity exceeds a certain criteria it is determined to be appropriate and may be added into the final named entity list. The cosine similarity may be used in the above Equation 2. As described herein, the named entity value N_{V} and named entity synonym Nₛ are embedded in the vector space to generate the embedding vectors E_{V} and Eₛ, and further, the cosine similarity is calculated using the dot product E_{V}·Eₛ of the embedding vectors E_{V} and Eₛ and the norm ∥Eᵥ∥∥Eₛ∥ of the embedding vectors E_{V} and Eₛ (S250).

When the cosine similarity is calculated by the Equation 2, the calculated cosine similarity is compared with a preset threshold (S260). As a result of the comparison, when the similarity value exceeds the threshold, operation proceeds to the next operation to add the named entity and the synonyms into the named entity list (Y in S260). On the other hand, when the similarity value does not exceed the threshold and thus does not meet the similarity threshold, the generated synonym is added into the blacklist to prevent duplicate generation (S201), and then the prompt is regenerated to return to the operation of regenerating the named entity again (S202).

The AI analyzer 150 adds the named entity and the synonyms that meet the similarity threshold into the named entity list (S270).

In this example embodiment, the AI analyzer 150 may further perform a process of determining whether the number of synonyms for the named entity satisfies a previously set criterion (S280). In this process, when the synonym satisfies the criterion, a follow-up process for storing the synonym is performed (S290), when the number of synonyms does not satisfy the criterion, the generated synonym is added into the blacklist to prevent duplicate generation (S201), and the prompt is regenerated to return to the operation of regenerating the named entity again (S202).

Valid named entities and synonym lists may be generated according to the above process, and the generated named entities and synonym lists will be automatically reflected into the named entity dictionary of the AI platform after administrator approval.

The AI analysis operation (S200) may be terminated or maintained in a standby state when data is not transmitted from the webpage change detector 140.

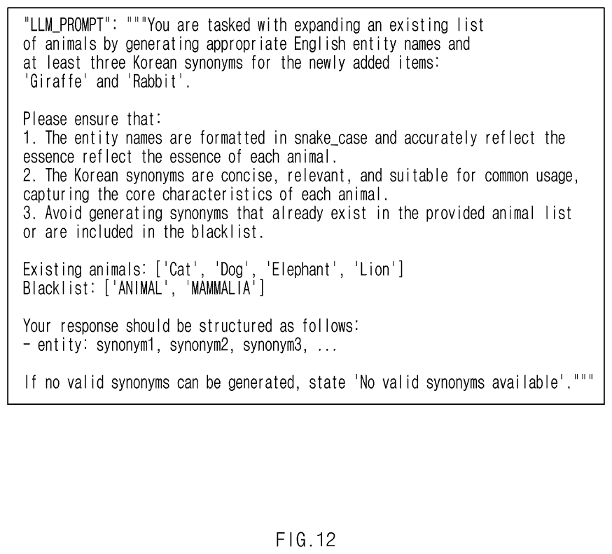

FIG. 12 is a diagram illustrating an example of an operation of an AI analyzer.

When the AI analyzer 150 receives changed data, for example, with the addition of Giraffe and Rabbit, the AI analyzer 150 may generate a prompt as illustrated in FIG. 12.

Then, the AI analyzer 150 may use the prompt to generate the added named entities, Giraffe and Rabbit, and synonyms for the named entities, as illustrated in Table 1 below.

TABLE 1

| Named entity | Synonyms |
|---|---|
| Giraffe | giraffe, spotted giraffe, long-necked |
| | animal |
| Rabbit | rabbit, domestic rabbit, wild hare |

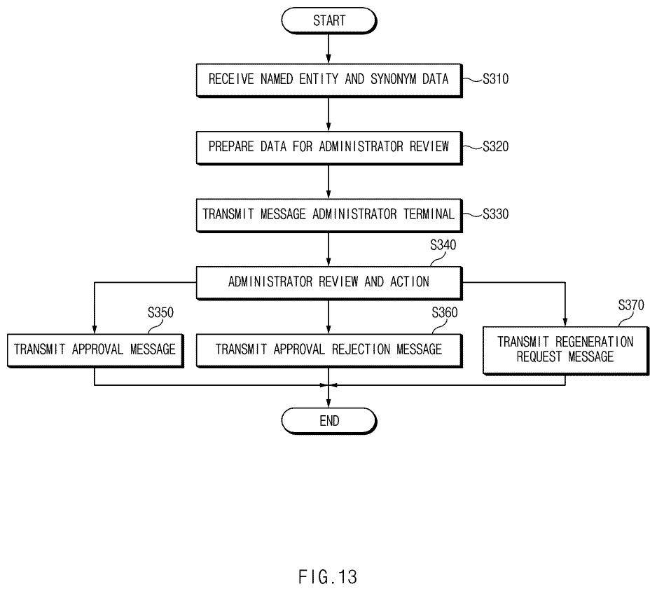

The AI analyzer 150 determines suitability by calculating the cosine similarity between the generated named entity and the synonym when it is confirmed that the added Giraffe and Rabbit do not exist previously. Then, when all of the named entities exceed the similarity criteria and the number of synonyms also meets the criteria, they are transferred to operation for administrator approval. FIG. 13 is a flowchart illustrating an administrator approval request operation of FIG. 8 in detail.

The administrator approval request operation (S300) may be initiated by the administrator terminal 200 receiving named entity and synonym data as illustrated in Table 1 from the AI analyzer 150 (S310). Then, the data is prepared such that the administrator may review the data (S320). In this preparation operation, the data is organized, and a message to be transmitted to the administrator may be composed.

The AI analyzer 150 transmits a message including the named entity and synonym data to the administrator terminal 200 in a form such as KakaoTalk, REST API, Slack, email, text message, etc. (S330).

The administrator may review the named entity and synonym data transmitted through the administrator terminal 200 and may select one of an approval, cancellation, and/or regeneration request through the administrator menu of the administrator terminal (S340). When approval is selected, the administrator terminal 200 may generate an approval message and transmit it to the server 100 (S350). When the cancellation is selected, the administrator terminal 200 may generate an approval rejection message and transmit it to the server 100 (S360). When a regeneration request is selected, the administrator terminal 200 may generate a regeneration request message so as to transmit it to the server 100 (S370). In this case, the server 100 performs the task of regenerating the named entity and the synonym data.

Meanwhile, when there is no response for a specific period of time regarding the named entity and the synonym data, the administrator approval request operation (S300) may be terminated. Of course, when there is no response, it may be designed such that the request may be made repeatedly until the administrator reviews it or a certain number of times, depending on the administrator settings.

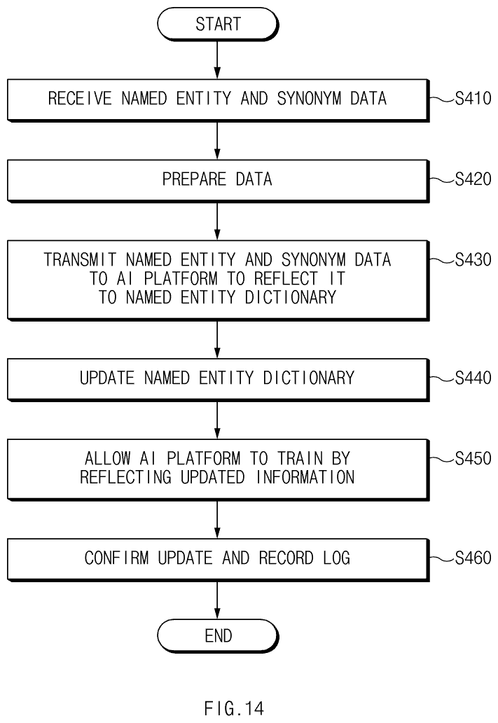

FIG. 14 is a flowchart illustrating an AI platform update operation of FIG. 8 in detail.

The AI platform update operation (S400) may be initiated by the AI platform integrator 170 receiving the named entity and synonym data approved by the administrator from the administrator terminal 200 (S410).

The AI platform integrator 170 prepares the data received from the administrator terminal 200 (S420). In this case, the AI platform integrator 170 may convert the received data into a format that may be reflected in the AI platform or may perform additional processing.

Then, the AI platform integrator 170 in the server 100 is connected to the API platform. In this case, the AI platform integrator 170 may perform the connection process using, for example, Google's REST, gRPC, and a client library supported by the AI platform. When the AI platform integrator 170 is connected to the API platform in this way, the AI platform integrator 170 transmits the named entity and the synonym data to the API platform (S430). The API platform adds the transmitted named entity and the synonym data into the named entity dictionary, and the named entity dictionary is automatically updated accordingly (S440).

When the named entity dictionary of the API platform is updated, the API platform performs training by reflecting the updated information, so that the AI model trains and applies the updated information (S450). Then, when the update is completed, the API platform records a log (S460).

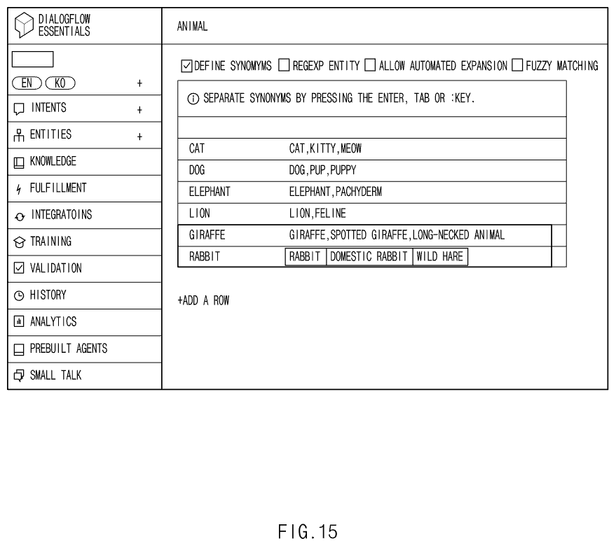

The API platform update operation (S400) is terminated by this process, and when a named entity search request occurs thereafter, the server 100 may provide the search result by reflecting the named entity and the synonyms added to the named entity dictionary, as illustrated in FIG. 15.

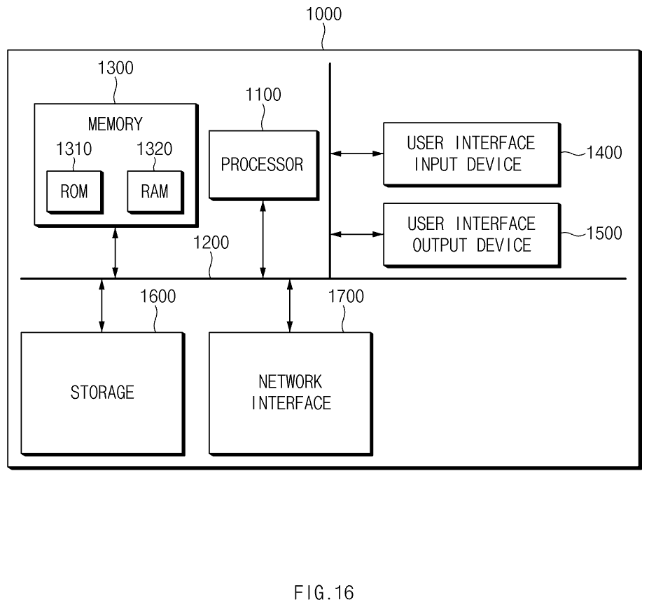

FIG. 16 illustrates a computing system according to an example embodiment of the present disclosure.

Referring to FIG. 16, a computing system 1000 may include at least one processor 1100, a memory 1300, a user interface input device 1400, a user interface output device 1500, storage 1600, and/or a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, the operations of the method (or algorithm) described in connection with the example embodiments disclosed in the specification may be (e.g., directly) implemented with a hardware module, a software module, or a combination of the hardware module and the software module, which may be executed by at least one processor, such as the processor 1100. The software module may reside on a storage medium (e.g., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium, as an example, may be coupled to the processor 1100. The processor 1100 may read out information from the storage medium and may write information into the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is illustrative of the technical idea of the present disclosure, and those of ordinary skill in the art to which the present disclosure pertains may be able to make various modifications and variations without departing from the present disclosure.

That is, the above-described embodiment describes a configuration example that detects (e.g., in real time) whenever new content is uploaded onto a webpage and updates the named entity dictionary with changed elements, but it may be applied in various ways.

For example, the present disclosure may be applied to an example embodiment that integrates a data source that may expand the system by detecting changes in a JSON API, an RSS feed, or a database. The example embodiment may also include inputting updated data that supports multiple languages by designing the LLM model to be able to process multiple language prompts so that named entities and synonyms may be generated in multiple languages. The example embodiment further may apply encryption technology in the data processing and transmission process. Also, the AI analyzer may separately manage sensitive information to strengthen the security of data. Also, the example embodiment may generate a user-customized prompt that provides a user interface so that the administrator may directly set the structure and content of the LLM prompt, thereby increasing the flexibility of the system and providing (e.g., enabling) the generation of customized data that meets specific requirements.

According to an example embodiment of the present disclosure, the example embodiment may detect changes on the webpage in real time and may update the changed elements in the named entity dictionary. Therefore, without the hassle of manually monitoring webpages or checking for changes, changes may be quickly reflected in the named entity dictionary, so that the latest named entity dictionary information may (e.g., always or continuously) be provided. This may improve performance of the AI model, and thus, the accuracy of the AI model may also improve.

In addition, the present disclosure (e.g., automatically) generates named entities and synonyms for changes to webpages, which may improve the level of automation in data management and may minimize the intervention of human resources for data updates. In addition, minimizing the intervention of human resources may reduce errors that may occur due to data management, which may improve data reliability.

In addition, the present disclosure filters similar items through a cosine similarity calculation and provides an administrator approval and confirmation process, so it may prevent duplication with existing data, thereby maintaining the consistency and quality of data. This improves the integrity of data within the system.

Additionally, the present disclosure provides administrators with request options to approve, reject, and/or regenerate generated named entities and synonym data, thereby increasing the flexibility of the system and allowing it to be tailored to user needs.

In addition, other improvements identified directly or indirectly through this specification may be provided.

Therefore, example embodiments of the present disclosure are not intended to limit the technical spirit of the present disclosure, but are provided for the illustrative purpose, and the scope of the technical spirit of the present disclosure is not limited by these example embodiments. The present disclosure includes the attached claims, and (e.g., all) equivalents thereof.

What is claimed is:

1. A named entity dictionary automatic update system comprising:
a server, and an administrator terminal,
wherein the server includes:
a webpage change detector configured to crawl a webpage at regular intervals to detect whether a named entity of the webpage is changed;
an AI analyzer configured to generate a prompt to be used by a large-scale language model based on the changed named entity from the webpage change detector, and to allow the large-scale language model to automatically generate a named entity and synonyms of the named entity, using the generated prompt;
an administrator approval requestor configured to transmit the named entity and the synonyms generated by the AI analyzer to the administrator terminal to request an approval; and
an AI platform integrator configured to automatically reflect the named entity and the synonyms approved by the administrator terminal in a named entity dictionary of a conversational AI platform in response to the approval of the administrator terminal, and to allow the AI platform to apply to an artificial intelligence model after training based on updated information, wherein the named entity dictionary is updated in real time when a content of the webpage is uploaded,
wherein the administrator terminal selects at least one of approval, cancellation, or regeneration requests by an administrator from an administrator menu to respond to the server.

2. The named entity dictionary automatic update system of claim 1, wherein the webpage change detector includes:
a DOM tree generator configured to analyze an HTML document of the webpage to generate a DOM tree structure;
a tree edit distance calculator configured to calculate a tree edit distance to measure a structural difference between a DOM tree generated by the DOM tree generator and a previous DOM tree; and
a processing device configured to identify and determine whether the webpage is updated based on the calculated tree edit distance.

3. The named entity dictionary automatic update system of claim 2, wherein the webpage change detector further includes:
a DOM tree comparator configured to compare the DOM tree generated by the DOM tree generator with a previously stored DOM tree.

4. The named entity dictionary automatic update system of claim 2, wherein the tree edit distance includes minimum edit calculation items to transform one tree into another tree, and
wherein the minimum edit calculation items include at least one of insertion, deletion, or replacement.

5. The named entity dictionary automatic update system of claim 2, wherein the processing device is further configured to:
determine a structural difference between the two trees based on a result of the tree edit distance being greater than zero, and
process the tree edit distance with priority over other tree edit distances when the tree edit distance exceeds a preset threshold value.

6. The named entity dictionary automatic update system of claim 1, wherein the AI analyzer includes:
a vector embedding generator configured to embed the named entity N_{V} and a named entity synonym Nₛ in a vector space to generate embedding vectors E_{V} and Eₛ; and
a similarity calculator configured to measure a similarity between the embedding vectors E_{V} and Eₛ of the generated named entity and the named entity synonym.

7. The named entity dictionary automatic update system of claim 6, wherein the similarity calculator:
calculates the similarity using a cosine similarity; and
calculates the similarity between the two embedding vectors E_{V} and Eₛ using Equation
$${cosine}_{similarity ( {E}_{v} , {E}_{s} )} = \frac{{E}_{v} \cdot {E}_{s}}{‖ {E}_{v} ‖ ‖ {E}_{s ‖}} ,$$
where E_{V}·Eₛ is a dot product of the embedding vectors E_{V} and Eₛ, and ∥Eᵥ∥∥Eₛ∥ represents a norm of the embedding vectors E_{V} and Eₛ.

8. The named entity dictionary automatic update system of claim 6, wherein the AI analyzer:
adds the named entity into a blacklist and regenerates the named entity based on the generated named entity already existing; and
adds the generated synonym into the blacklist to prevent duplicate generation and regenerates the named entity based on the similarity that does not meet a criteria as a result of the similarity calculation.

9. The named entity dictionary automatic update system of claim 6, wherein the AI analyzer:
determines whether a number of synonyms for the generated named entity satisfies a preset criteria; and
adds the generated synonyms into a blacklist to prevent duplicate generation and then regenerates the named entity based on the number of synonyms that does not meet the preset criteria.

10. The named entity dictionary automatic update system of claim 1, wherein the administrator terminal:
receives an approval request for the named entity and the synonym data from the administrator approval requestor.

11. A method of operating a named entity dictionary automatic update system including a server and an administrator terminal, the method comprising:
crawling a webpage at regular intervals to detect whether a named entity of the webpage is changed;
generating a prompt to be used by a large-scale language model based on the changed named entity provided from crawling the webpage, and automatically generating, via the large-scale language model, a named entity and synonyms of the named entity using the generated prompt;
transmitting data of the named entity and the generated synonyms to the administrator terminal to request approval; and
automatically reflecting the named entity and the synonyms approved by the administrator terminal in a named entity dictionary of a conversational AI platform in response to the approval by an administrator on the administrator terminal, and allowing the AI platform to apply to an artificial intelligence model after training based on updated information,
wherein the named entity dictionary is updated in real time when a content of the webpage is uploaded.

12. The method of claim 11, wherein detecting whether a named entity of the webpage is changed comprises:
analyzing an HTML document of the webpage to generate a DOM tree structure;
calculating a tree edit distance to measure a structural difference between the generated DOM tree and a previous DOM tree; and
identifying and determining whether the webpage is updated based on the calculated tree edit distance.

13. The method of claim 12, wherein detecting whether a named entity of the webpage is changed further comprises comparing the generated DOM tree with a previously stored DOM tree.

14. The method of claim 12, wherein the tree edit distance includes minimum edit calculation items to transform one tree into another tree, and
wherein the minimum edit calculation items include at least one of insertion, deletion, or replacement.

15. The method of claim 12, wherein determining whether the webpage is updated based on the calculated tree edit distance comprises:
determining a structural difference between the two trees based on a result of the tree edit distance being greater than zero; and
processing the tree edit distance with priority over other tree edit distances based on the tree edit distance exceeding a preset threshold value.

16. The method of claim 11, wherein automatically generating, via the large-scale language model, a named entity and synonyms of the named entity using the generated prompt comprises:
embedding the named entity N_{V} and a named entity synonym Nₛ in a vector space to generate embedding vectors E_{V} and Eₛ; and
measuring a similarity between the embedding vectors E_{V} and Eₛ of the generated named entity and the named entity synonym.

17. The method of claim 16, wherein measuring the similarity between the embedding vectors E_{V} and Eₛ comprises:
calculating the similarity using a cosine similarity, and
calculating the similarity between the two embedding vectors E_{V} and Eₛ using Equation
$${cosine}_{similarity ( {E}_{v} , {E}_{s} )} = \frac{{E}_{v} \cdot {E}_{s}}{‖ {E}_{v} ‖ ‖ {E}_{s ‖}}$$
where E_{V}·Eₛ is a dot product of the embedding vectors E_{V} and Eₛ, and ∥E_{V}∥∥Eₛ∥ represents a norm of the embedding vectors E_{V} and Eₛ.

18. The method of claim 16, wherein automatically generating, via the large-scale language model, a named entity and synonyms of the named entity using the generated prompt comprises:
adding the named entity into a blacklist and regenerating the named entity based on the generated named entity existing; and
adding the generated synonym into the blacklist to prevent duplicate generation and regenerating the named entity based on the similarity that does not meet a criteria as a result of the similarity calculation.

19. The method of claim 16, wherein automatically generating, via the large-scale language model, a named entity and synonyms of the named entity using the generated prompt comprises:
further determining whether the number of synonyms for the generated named entity satisfies a preset criteria; and
adding the generated synonyms into a blacklist to prevent duplicate generation and then regenerating the named entity based on the number of synonyms that does not meet the preset criteria.

20. The method of claim 11, wherein the administrator terminal selects at least one of approval, cancellation, or regeneration requests of an administrator menu for the administrator to respond to the server based on an approval request for the named entity and the synonym data received from the administrator approval request.
